(19) United States
(12) Patent Application Publication
(10) Pub. No.: US 2005/0225100 A1
(43) Pub. Date: Oct. 13, 2005

(54) Rocking doorstop

(76) Inventor: Michael Pendergrass, Rocklin, CA (US)

Correspondence Address: JOHN P. O'BANION;O'BANION & RITCHEY LLP, 400 CAPITOL MALL SUITE 1550, SACRAMENTO, CA, 95814, US

(21) Appl. No.: 11/101,052

(22) Filed: Apr. 6, 2005

Related U.S. Application Data
(60) Provisional application No. 60/560,802, filed on Apr. 7, 2004.

(51) Int. Cl. E05C 5/00

(52) U.S. Cl. 292/343

(57) ABSTRACT

A rocking doorstop comprises a base portion having a lower surface for placement on a surface in proximity to a door. A first arm is coupled to the base portion such that the first arm is configured to engage a door as a result of motion of the door in a first direction. A second arm is also coupled to the base portion, wherein the second arm is configured to engage the door as a result of engagement of the first arm with the door. The engagement between the first and second arms and the door retains motion of the door in the first direction. The first arm is generally configured to engage the front surface of the door. The second arm is configured to engage the bottom surface of the door via a rocking motion created by the door engaging the first surface.

### CROSS-REFERENCE TO RELATED APPLICATIONS

This application claims priority from U.S. provisional application Ser. No. 60/560,802 filed on Apr. 7, 2004, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to door stops, and more particularly to an improved door stop that rocks and locks into place.

2. Description of Related Art

Door stops are ubiquitous. Generally, they are used to keep a door open or in an open position in opposition to a closing or loading force such as a spring-loaded hinge, gust of wind, or other force. However, the conventional wedge-type door stops that are commonly available in the art suffer from numerous drawbacks.

First, the wedge-type doorstop 10 illustrated in FIG. 1 is prone to slipping and to being pushed away by the loading force F_{d} of the door 12. As most doors are hinged to swing open and closed in a manner parallel to the floor, the loading force F_{d} is also parallel to the floor 14. Loading force F_{d} may be from a variety of forces, including torsion or other spring loading on the door, or external forces such as gusts of wind or manual loading by a person.

The wedge-type door stop 10, and the majority of other door stops available in the art, rely on friction to retain the door from moving. The static frictional force, Fₛ, is governed by the equation:
Fₛ=μₛ×N
where μₛ is the static coefficient of friction, and N is the force normal to surface 14 opposing the doorstop 10. Because the force F_{d} is generally parallel to the floor 14, little, if any, of the force from the door translates into force N. Thus the static frictional force may be calculated as follows:
   Fₛ=μₛ×mg
where m is the mass of the doorstop and g is the gravitational constant. Since wedge-type doorstops inherently have little mass, the static frictional force, Fₛ is typically smaller than the force F_{d}, especially for a smooth floor having a low coefficient of friction. The result is the stop failing to restrain the door in the direction of force F_{d}. Some devices, attempt to solve this problem by increasing the coefficient of friction coefficient of friction μₛ of the bottom surface of the doorstop, as shown in U.S. Pat. No. 3,328,065. However, for many surfaces, the resulting static frictional force Fₛ is still insufficient to withstand load L.

To overcome this problem, many users apply a considerable amount of force to jam the doorstop under the door to create the resistance necessary to overcome the door's loading force. This wedging of the doorstop under the door creates an additional downward force by either loading the weight of the door on the doorstop, or deforming the material 16 to create a downward compressive spring force. In many situations, this procedure is ineffective.

As a result, the jamming procedure required by such conventional door stops is often difficult and time consuming to secure in place. In addition, the resulting additional force often makes the wedge-type door stop difficult to remove, and causes deformation of the stop itself.

Furthermore, most wedge-type door stops are not capable of accommodating a wide range of door gaps. For example, if the gap between the floor and the bottom of the door is over one and one-half inches, the door will swing past the stop without engaging it.

An additional drawback of the wedge-type door stop is the long length necessary to accommodate a typical range of doors. This length causes that doorstop to protrude outward from the door. This is not only unsightly, but also increases the probability that a person may trip over the doorstop when passing by the door.

### BRIEF SUMMARY OF THE INVENTION

The present invention solves the slip problem associated with conventional wedge-type door stops. By way of example, and not of limitation, a door stop according to the present invention is disclosed that rocks to form a three-point contact with the door and a floor surface to direct the door's energy downward and force the door stop to lock into place. A door stop according to the present invention is not wedged into place, but rocks and locks into place without the need for additional force. In addition, a door stop according to the present invention will not get stuck under the door like a conventional wedge-type door stop.

The rocking doorstop of the present invention is based on three energy points which generate the systematic rocking action. When pressure is applied to the top of the doorstop by a door, it rocks back and locks into place by the force of the door. As a result, the doorstop does not need to be wedged or forced under a door to work. The point at which the door rests allows the edge or corner of the door to float freely during the rocking motion. While holding the door open, the corner or edge of the door does not touch the doorstop. Therefore the door will not cut, tear or collapse the rocking door stop, unlike the wedge-type doorstop.

In one aspect of the invention, a doorstop comprises a base portion having a lower surface for placement on a surface in proximity to a door. A first arm is coupled to the base portion such that the first arm engages the door as a result of motion of the door in a first direction. A second arm is also coupled to the base portion, wherein the second arm engages the door as a result of engagement motion of the first arm with the door. The engagement between the first and second arms and the door retains motion of the door in the first direction.

In a preferred mode of the present aspect, the first arm is configured to engage a first surface of a door as a result of motion of the door in the first direction such that engagement of the first arm with the first surface of the door causes at least a portion of the doorstop to pivot to engage the second arm with the second surface of the door. In many embodiments, the second surface is substantially perpendicular to the first surface.

In another mode of the current aspect, the base portion has a lower surface for placement on a surface in proximity to the door. A portion of the lower surface comprises a curvilinear surface such that engagement of the first arm with the first surface of the door causes the doorstop to rock backward on said curvilinear surface to engage the second arm with the second surface.

Typically, the surface in proximity to the door comprises a floor surface below said door, the first surface is a front panel of the door, and the second surface is a bottom panel of the door. The second arm may be configured to fit under a gap between the floor surface and the bottom panel of the door, allowing motion of the door over the second arm prior to contacting the first arm. Preferably, the second arm rotates upward to engage the bottom panel of the door as the doorstop rocks on said curvilinear surface.

When the doorstop is placed on the floor, the door is balanced between the first arm and the second arm to generate a vertical force between the floor and the lower surface of the doorstop, wherein the vertical force restrains motion of the door in the first direction.

In an alternative embodiment, the surface in proximity to the door comprises a door jam surface. In such an embodiment, the first surface is a hinge panel of the door, and the second surface is a rear panel of the door.

In another embodiment, the first arm and the second arm define a pivoting member pivotably connected to the base portion, wherein engagement of the first arm with the first surface causes the pivoting member to pivot such that the second arm moves toward the second surface to engage the second surface.

Another aspect of the invention is a method of restraining motion of a door in a first direction, comprising placing a doorstop having a first contact point and a second contact point on a surface in proximity of the door, engaging the first contact point of the doorstop as a result of motion of the door in the first direction, engaging the second contact point of the doorstop as a result of motion of the first contact point in the first direction, and balancing the door between the first contact point, second contact point, and proximate surface to restrain the door from moving in the first direction.

In one mode of the current aspect, engaging the first contact point comprises engaging a first surface of the door as a result of motion of the door in the first direction, and engaging the first contact point comprises engaging a second surface of the door as a result of motion of the first contact point in the first direction.

Furthermore, the current aspect may include the step of rocking at least a portion of the doorstop as a result of motion of the first contact point in the first direction.

In one embodiment, the doorstop comprises a lower surface having a curvilinear surface, wherein rocking at least a portion of the doorstop comprises engaging the first contact point with the first surface of the door such that the doorstop rocks backward on said curvilinear surface to engage the second contact point with the second surface.

In an alternative embodiment, the first contact point and second contact point are located on a pivoting member pivotably connected to a base member of the doorstop, wherein rocking at least a portion of the doorstop comprises engaging the first contact point with the first surface of the door such that the pivoting member pivots backward on said curvilinear surface to engage the second contact point with the second surface.

In another embodiment, the doorstop may be placed on a floor surface in front of the door such that a front surface of the door engages the first contact point as a result of motion of the door in the first direction. Additionally, the second contact point engages a bottom surface of the door as a result of motion of the first contact point in the first direction. Typically, the door advances over the second contact point prior to engaging the first contact point, and the second contact point rotates upward to engage the bottom surface of the door.

In yet another embodiment, the door is balanced between the first contact point and the second contact point to generate a vertical force between the floor and doorstop.

The method of the current aspect may also include applying pressure to the door in a second direction to disengage the doorstop from the door, wherein the second direction is substantially opposite to said first direction.

In another aspect of the invention, a doorstop is disclosed for retaining a door moving in a first direction under a force directed substantially in the first direction. The doorstop comprises a base member having a first contact point and a second contact point, and means for balancing the door between the first contact point and the second contact point to retain the door from motion in the first direction.

In one mode of the current aspect, the base member further comprises a lower surface configured to engage a floor surface in proximity to the door, wherein the first contact point and the second contact point are configured to transfer the a portion force in the first direction to a second direction having a vertical component. Generally, the vertical component contributes to a static friction force opposing the door in the first direction.

In one mode of the current aspect, the doorstop further includes an anti-sliding means coupled to the base member. In some embodiments, the anti-sliding means is integral with base member. Alternatively, the anti-sliding means may be a separate layer attached to the base member.

In many embodiments, the balancing means comprises a curvilinear surface on the lower surface of the body member. The curvilinear surface is configured to allow the doorstop to rock backward to contact the door with the second contact point after engagement with the door and the first contact point.

In alternative embodiments, the balancing means comprises a pivoting member housing the first contact point and the second contact point. The pivoting member is configured to pivot about a point on the base member upon engagement of the first contact point and the door.

In another aspect of the invention, a doorstop comprises a first member having a first inclined upper surface for engaging a door, and a second member pivotally coupled to said first member. The first member has a cavity configured for receiving said second member such that the second member may be pivoted from a first position nested within the cavity, to a second position on the upper surface of the first member. The doorstop may further comprise a retention member for retaining the first member within the cavity of the second member. Generally, the first member and the second member create a second inclined surface that has a higher profile than the first inclined surface.

In yet another aspect of the invention, a doorstop comprises a first wedge portion and a second wedge portion pivotally coupled to the first wedge portion. The first wedge portion has a cavity configured for receiving said second wedge portion. In a first position, the second wedge portion is nested within the cavity, and in a second position, the second wedge portion is folded back and rests on top of said first wedge portion. In the second position, the first wedge and the second wedge create a higher profile than when the second wedge is nested in the first position.

In a further aspect of the invention, a doorstop cradle is disclosed for holding a doorstop while not in use. The cradle comprises an enclosure having a cavity configured to retain the doorstop, an opening on one side of the enclosure for insertion of the doorstop, and means for attaching the enclosure to a vertical surface. The attachment means may be configured to attach the enclosure to the side of a door, or to a wall surface adjacent the door. The cradle may be used to keep the door stop on the door and out of the way until the user needs it. In some embodiments, the cradle is secured to the door using screws or an adhesive material.

A still further aspect of the invention is a riser pad used to elevate the door stop by attaching the pad to the base of the door stop. In some embodiments, the pads are different thicknesses to give the user options for larger gaps from floor to door openings.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic diagram of a wedge-type doorstop in use with a common door.

FIG. 2A illustrates a side view of a rocking doorstop in accordance with the present invention.

FIG. 2B illustrates a front view of the rocking doorstop of FIG. 2A.

FIG. 2C illustrates a bottom view of a rocking doorstop of FIG. 2A.

FIG. 2D illustrates a rear view of a rocking doorstop of FIG. 2A

FIGS. 3A-3C illustrate the manner of operation of the door stop of FIGS. 2A-D at the bottom surface of the door.

FIG. 3D illustrates the manner of operation of the door stop of FIGS. 2A-D between the hinge panel of the door and the door jam.

FIG. 4A is a perspective view of an alternative doorstop of the present invention.

FIG. 4B is a side view of a doorstop in accordance with the present invention.

FIGS. 5A-C illustrate a doorstop having external ridges and mating floor-pad in accordance with the present invention.

FIGS. 6A-B illustrate a doorstop having serrated external ridges in accordance with the present invention.

FIGS. 7A-B illustrate a doorstop having external buttons in accordance with the present invention.

FIGS. 8A-C illustrate riser pad used in conjunction with the doorstop of the present invention.

FIGS. 9A-C show an embodiment of a cradle device for the door stop of the present invention.

FIGS. 10A-B illustrate an embodiment of a door stop which uses a stationary base member and pivoting contact member according to the present invention.

FIGS. 11A-C illustrate the manner of operation of the door stop of FIG. 10A-B.

FIGS. 12A-C illustrate an alternative two-piece wedge-type doorstop in accordance with the present invention.

FIGS. 13A-C illustrate the manner of operation of the door stop of FIGS. 12A-C.

### DETAILED DESCRIPTION OF THE INVENTION

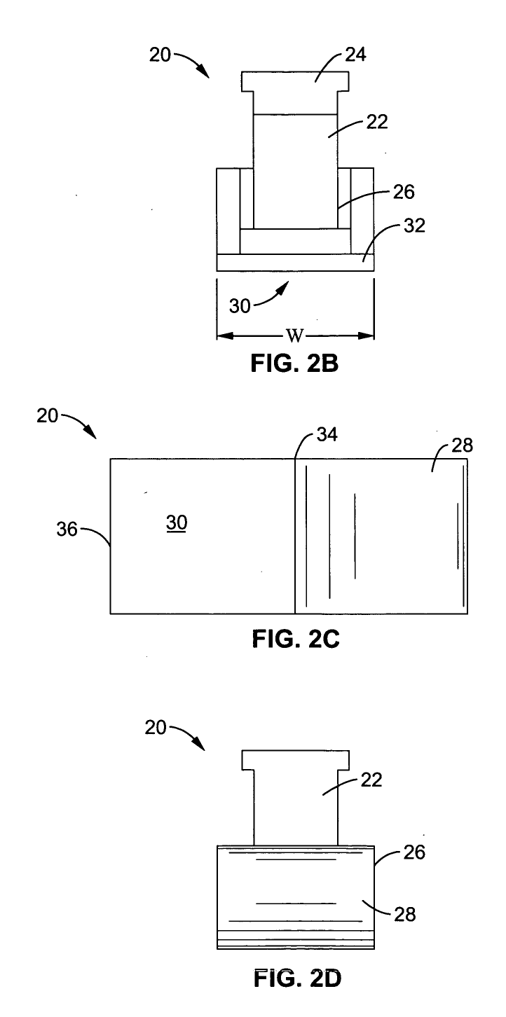

Referring more specifically to the drawings, for illustrative purposes the present invention is embodied in the apparatus generally shown in FIG. 2A through FIG. 13C. It will be appreciated that the apparatus may vary as to configuration and as to details of the parts, and that the method may vary as to the specific steps and sequence, without departing from the basic concepts as disclosed herein.

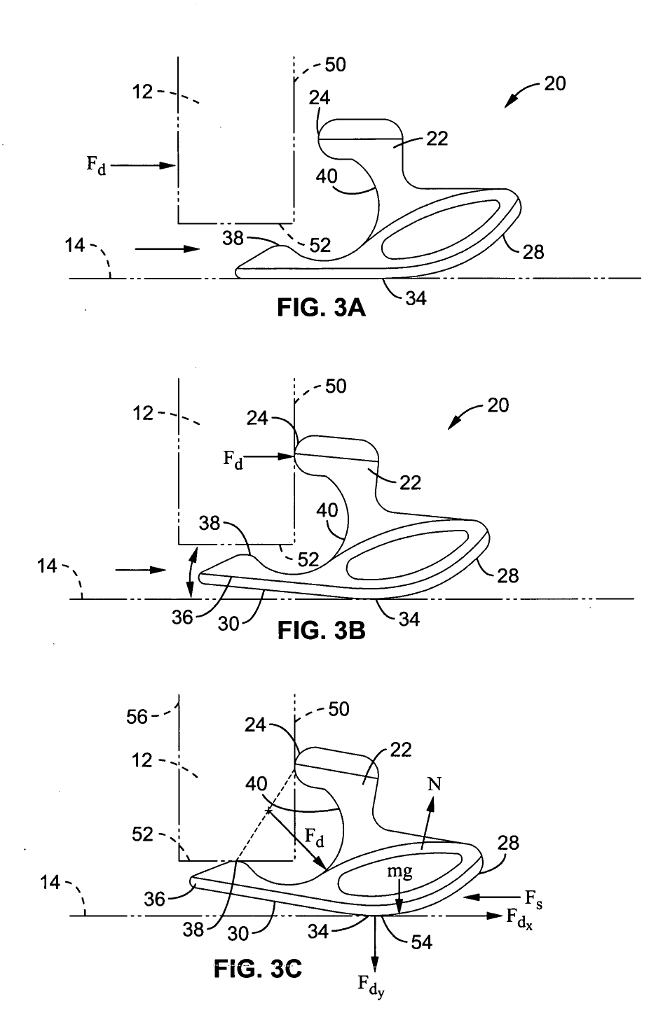

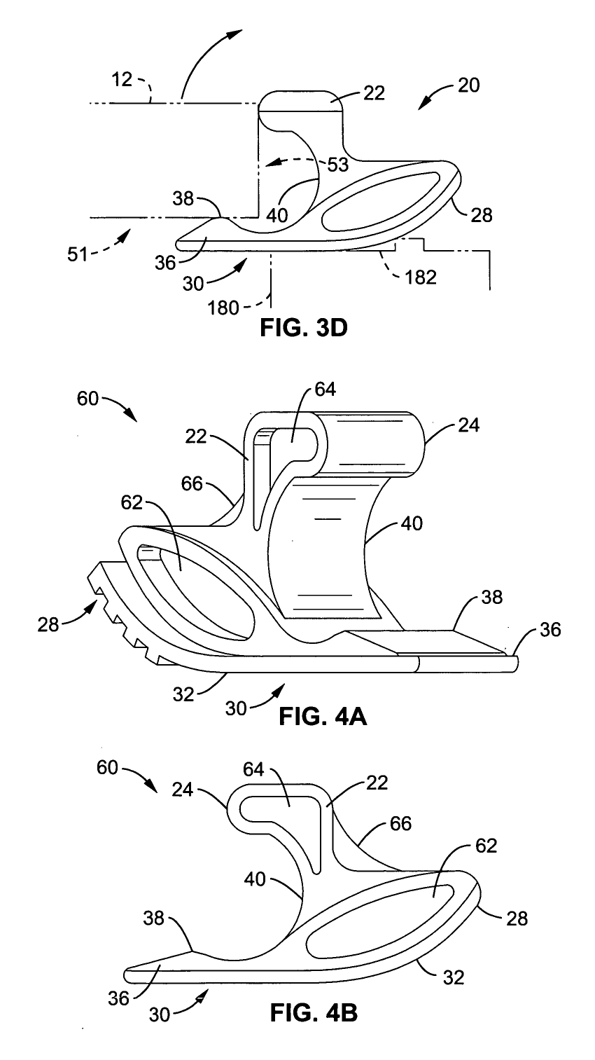

Referring to FIGS. 2A-D, a rocking doorstop 20 in accordance with the present invention is shown in side, front, bottom and rear views, respectively. Doorstop 20 has a body section 26 supporting lower arm 36 and upper arm 22. Arms 36 and 22 have contact points 38 and 24 respectively. Contact points 38 and 24 are separated by a curvilinear cutout 40 having an internal radius Rᵢ defining an opening having gap dimension G. The internal radius Rᵢ of curvilinear cutout 40 allows clearance of door 12 as shown in FIG. 3A-C.

Body section 26 and arm 36 integrally form lower surface 30 that is configured to interface with a surface close to the door such as floor 14. The lower surface 30 is generally flat along the extent of lower arm 36 and a portion of body section 26 until it curves upward at point 34 to form a curved section 28. Curved section 28 generally follows a circumferential path having an outer radius Rₒ.

The height H₁ of the doorstop 20 is generally defined by placement of the upper arm 22, and may vary to accommodate different sized door gaps. However, for universal use, a height of 2 to 2½ inches is generally sufficient to interface with most doors. The height H₂ Of the lower arm 36 is defined by the distance between the lower surface 30 and the lower contact point 38, and is sized such that the bottom surface 52 of door 12 freely advances over the lower arm 36 until contact is made with the upper arm 22. The height H₂ Of the lower arm 36 is also controlled by the gap G of the curvilinear cutout 40. The gap G is sized to optimize the contact of the upper and lower arms for a given door thickness and gap between the door and the floor. If the gap is sized too small, the upper arm 22 may not be of sufficient height to contact the door for doors having large floor gaps. If the gap G is sized too large, the lower arm 36 may slide under the bottom surface 52 and over to the back side of the door 56. For a typical door thickness of 1½ in., a gap G of approximately 1⅜″ and lower arm height H₂ of 5/16″ were found to be optimal for proper interface.

FIGS. 3A-3C illustrate the mechanics of doorstop 20 as used with a typical door 12 in accordance with the present invention. Referring to FIG. 3A, doorstop is placed on the floor 14 at the location where the door 12 is to be retained, with the upper and lower arms, 22 and 36, facing the front panel 50 of door 12. With the door passing left to right under load F_{d}, the bottom surface of the door 52 passes over lower arm 36 until the front panel of the door 50 contacts the upper contact point 24 of the upper arm 22.

As shown in FIG. 3B, the lateral or horizontal loading L from the door 12 causes the doorstop 20 to pivot about point 34 on the lower surface and rock backward on the curved surface 28. This in turn causes the lower arm 36 to rise upward toward the bottom surface 52 of the door 12.

As shown in FIG. 3C, the doorstop continues to rock backward until the lower contact point 38 of lower arm 36 contacts the bottom surface 52 of the door 12. At this point, the rotational motion is restrained from the 3-points of contact: upper and lower points 24 and 38 between the doorstop 20 and the door 12, and rocking point 54 between the doorstop lower surface 28 and the floor 14. The three-point contact configuration results in a vertical loading component F_{dy} into the ground at rocking point 54, in addition to the horizontal loading component F_{dx}. The resulting static frictional force Fₛ created by the doorstop 20 will be governed by the following equation:
Fₛ=μₛ[mg+F_{dy}]
where m is the mass of the doorstop, g is the gravitational constant, and F_{dy} is the vertical loading component. Thus, a portion of the loading F_{d}, is redirected downward to restrain the door from moving. With the additional vertical loading component F_{dy} no jamming of the doorstop 20 under the door 20 is necessary to hold the door in place. The doorstop 20 is simply placed in the desired position in front of the door, and the door is released toward the doorstop under its own loading to be restrained by the doorstop once the 3-point contact configuration is achieved.

To release the door 12, only a slight pressure need be applied to push the door 12 backward against the loading force F_{d}, such that the doorstop 20 rocks forward back to the position shown in FIG. 3A. The doorstop may then be easily retrieved with little effort.

FIG. 3D illustrates an alternate method of using the doorstop 20 of the present invention on a door jam 180. With the door 12 open, the door stop 20 may be placed with the bottom surface 30 adjacent to the door jam surface 182. The lower arm 36 may be positioned in the crack between the door 12 and the door jam 180 near the rear panel of the door. As the door 12 starts to rotate shut, the hinge panel 53 of the door 12 contacts the upper arm 22 of the doorstop 20, causing the doorstop to rotate backward on surface 28 until the lower arm 36 contacts the rear panel 51 of the door. A three-point contact is then formed between the door jam and the door surfaces to retain further motion of the door.

As illustrated in FIGS. 2A-2C, doorstop 20 may have a flange 32 defining the bottom surface 30 and curved surface 28. The flange 32 extends beyond the body 26 in width to give more surface area (and therefore higher frictional component) to the bottom surface 30, while minimizing material and weight. Additional material conservation may be accomplished by relief region 62 and minimized thickness at the upper arm 22.

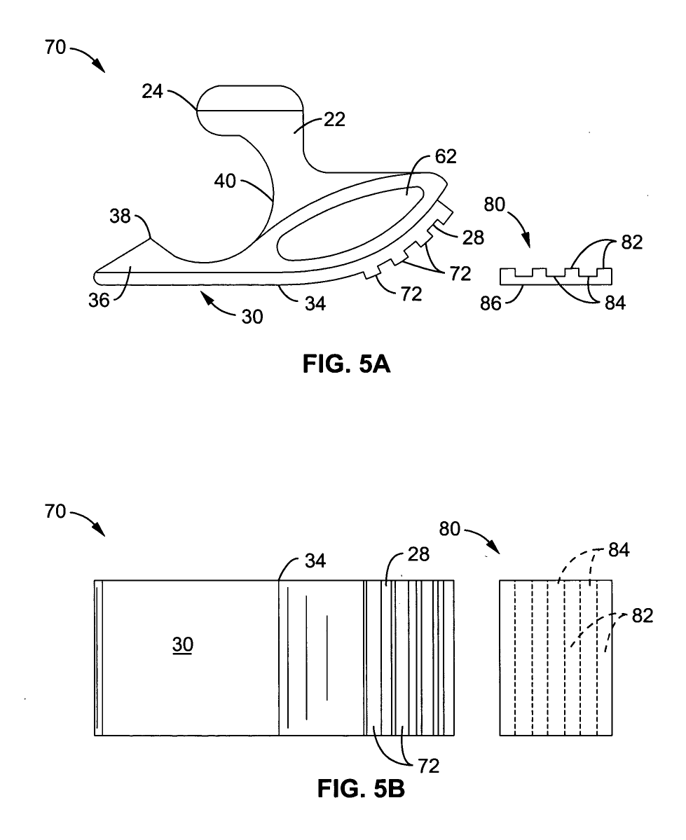

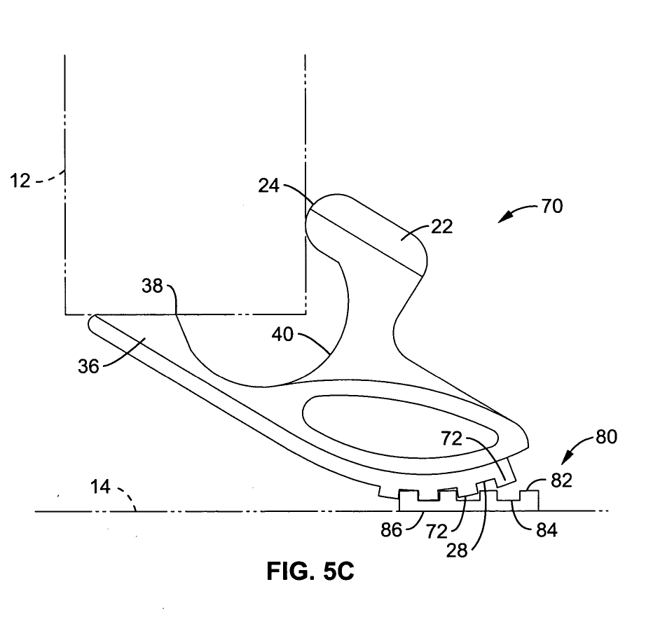

Further material relief may be seen in alternative doorstop 60 illustrated in side view FIG. 4A and in perspective view in FIG. 4B. For example, upper arm 22 may further include relief region 64 and gusset 66 to support a thinner cross section. As shown in FIG. 4B, curves surface 28 may also comprise a plurality of ridges which are detailed further below with respect to FIGS. 5A and 5B.

For general use, doorstop 20 may comprise a rubber or plastic material, such as thermoplastic elastomers (TPEs), or thermoplastic vulcanizates (TPVs), e.g. Santoprene™, Kraton™, Dytron™, or Pebax™. For more industrial or heavy-duty applications, materials such as acrylonitrile butadiene styrene (ABS), or thermoplastic vulcanizates, e.g. Vyram™, may be used to increase strength and durability. Although a number of different materials or polymers commonly used in the art may be used, TPE's such as Santoprene™ are particularly beneficial because of their desirably high frictional properties. Although it is less durable and rigid than other plastics, Santoprene™ is ideally suited for lower weight household doors.

Typically, the doorstop is made of a single material construction fabricated by an injection molding process (liquid material forced into a mold or cavity, which solidifies and then is removed). In some embodiments, the doorstop may comprise a combination of materials. For example, the flange 32 may comprise a soft, more sponge-like material such as Santoprene™, with the remainder of the doorstop comprising more rigid vulcanized rubber or ABS material. This may be accomplished by a dual-mold or two-step process to fuse the materials together. Alternatively, the flange 32 may be adhered as a strip to the bottom of the body section 26. In either of these configurations, the doorstop retains the high frictional properties at the lower surface, while maintaining high rigidity and strength through the body 26, and upper and lower arms 22 and 36.

Referring now to FIGS. 5A and 5B, a doorstop 70 in accordance with the present invention may comprise a plurality of protrusions or ridges 72 positioned on the curved surface 28 just aft of the end 34 of the flat lower surface 30. Ridges 72 provide additional frictional resistance as the doorstop rocks backward from point 34. Ridges 72 are preferably run perpendicular to the frictional component to provide increased resistance, and for ease of manufacturing when produced by plastic injection molding.

As illustrated in FIGS. 5A-5C, the doorstop 70 may be combined with a mating doorstop pad 80. The doorstop pad 80 may comprise an acrylic plastic and have a mating pattern of ridges 82 and valleys 84 that match the ridges 72 of the doorstop 70. The pad 80 may be placed at a desired point to restrain the door 12 and fastened to the floor 14 via either an adhesive backing on lower surface 86, or other fastening means such as one or more screws (not shown). As shown in FIG. 5C, motion of the door 12 causes the doorstop 70 to rock back onto the pad 80 such that the ridges 72 of the doorstop 70 interlock with the mating valleys 84 of the pad. This results in a much higher retention capability for retaining doors under extremely large loading.

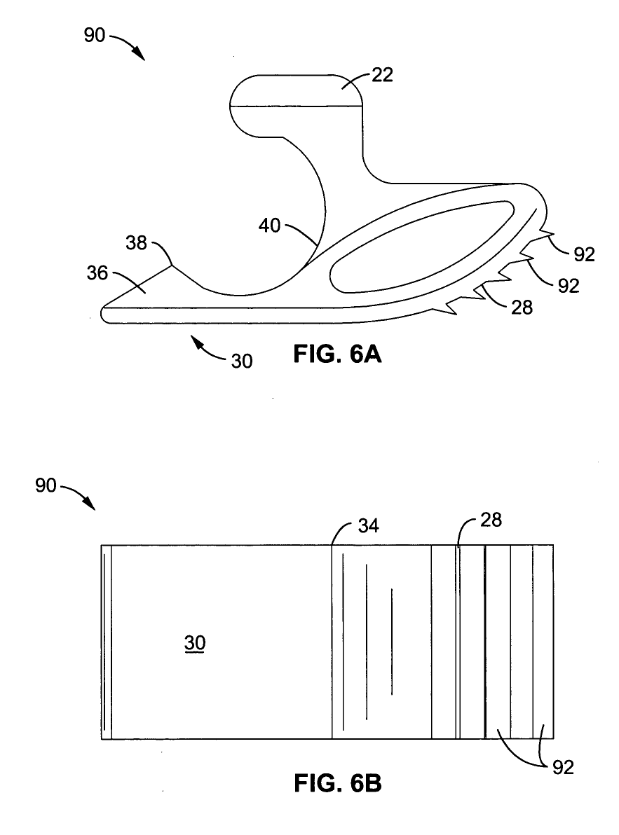

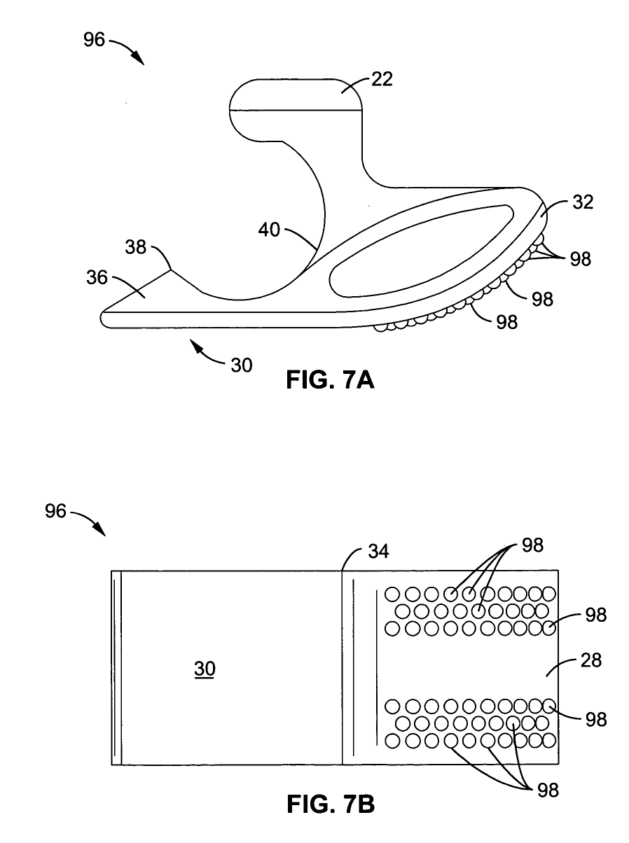

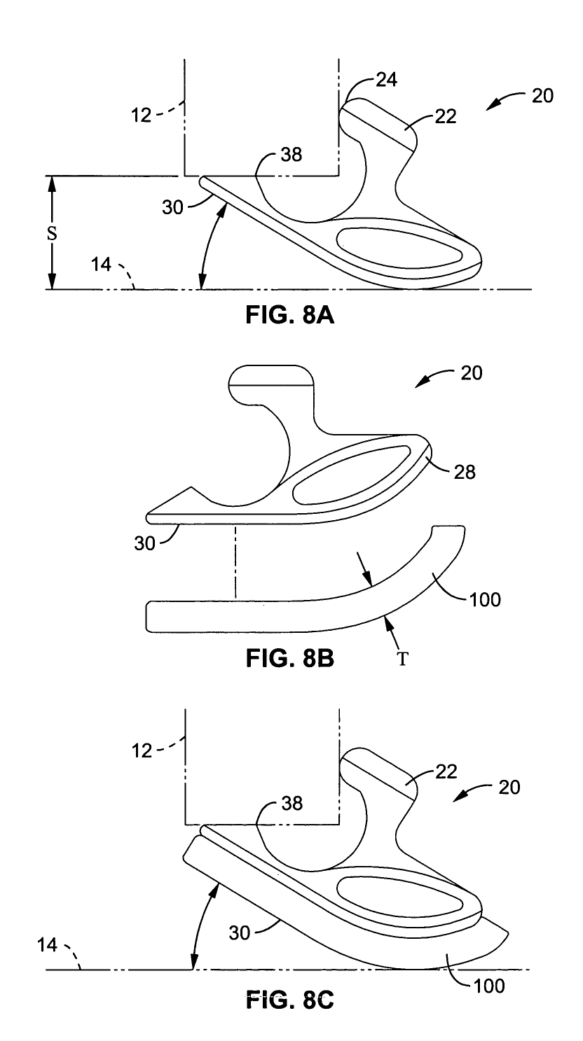

The protrusions disposed on the curved surface 28 may comprise a variety of different shapes or patterns. As illustrated in FIGS. 6A-6B, doorstop 90 may have a plurality of serrated ridges 92 spaced along the curved surface 28. This serrated pattern may provide additional resistance for particular surfaces.

Alternatively, a doorstop 100 may comprise a plurality of circular protrusions 98 spaced in an array across the curved surface 28. This embodiment may be particularly applicable with a two-piece doorstop, wherein the flange 32 may be molded separately to create protrusions 98 on the bottom surface.

Referring now to FIG. 8A, the doorstop 20 of the present invention is configured to accommodate a variety of floor-to-door spacing heights S, generally gaps from ⅜″ to over 2⅛″. However, if the spacing S is too high, then the door 12 will clear the upper arm 22 of the doorstop 20. To accommodate larger gap heights, a riser pad 100 may be used in combination with the doorstop 20, as illustrated in FIGS. 8B and 8C. The riser pad 100 attaches to the bottom surfaces 28, 30 of the doorstop to elevate the doorstop. Such attachment may be performed via adhesive, clips, or other fastening means. The riser pad 100 has a thickness T that may vary according to the application. For example, the thickness T may be ½″-1″, and multiple riser pads may be stacked together to achieve a particular height. The riser pad 100 is preferably a rubber or plastic material with gripping properties, such as Santoprene. As shown in FIG. 8C, with the riser pad 100 installed, the upper arm 22 is able to contact the door 12, thereby resulting in the 3-point contact configuration to restrain the door from additional motion.

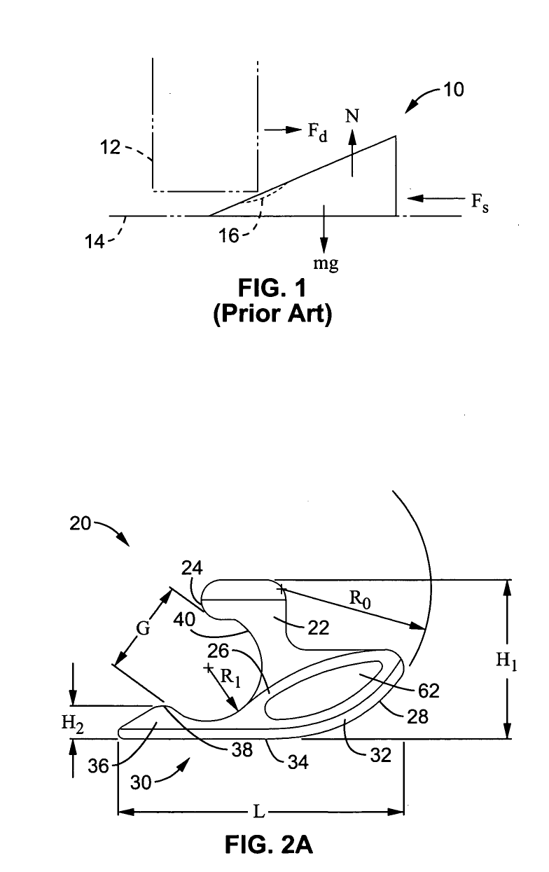

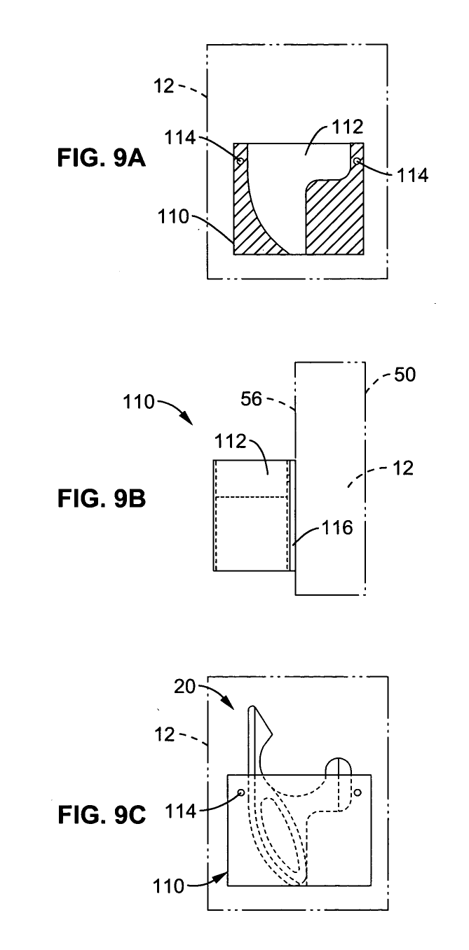

Referring now to FIGS. 9A-9C, a doorstop cradle 110 in accordance with the present invention may be used to hold doorstop 20 while the doorstop is not in use. The cradle keeps the doors stop off of the ground and out of the way of foot traffic, limiting loss or accidental tripping. The cradle has a cavity 112 configured to match the profile of doorstop 20. Alternatively, the cavity 112 may be configured to accommodate a variety of different doorstops, such as the wedge-type doorstop 10 shown in FIG. 1. The cradle may be mounted to the back surface 56 of door 12 via screw holes 114. Alternatively, the cradle may be mounted with double sided adhesive strip 116, such that an adhesive backing may be peeled off and the cradle pressed into place on the back surface 56 of door 12.

A drawstring (not shown) may be used to re-track the door stop from under the door when pressure is removed from the door stop. The string pulls the door stop up into the cradle and secures the door stop until needed.

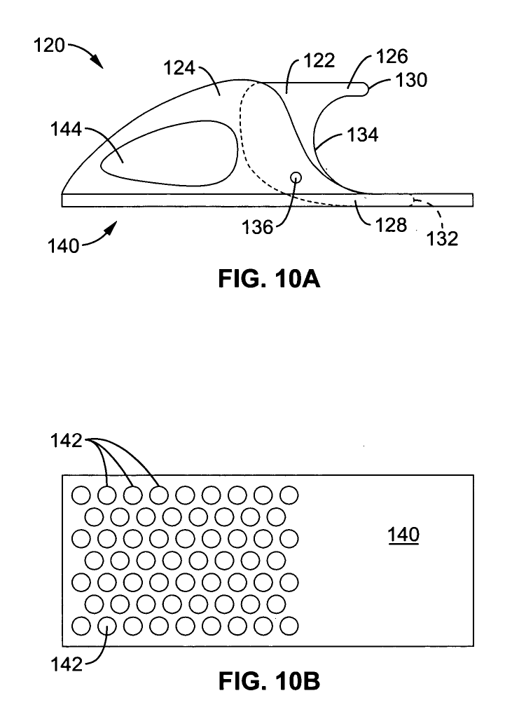

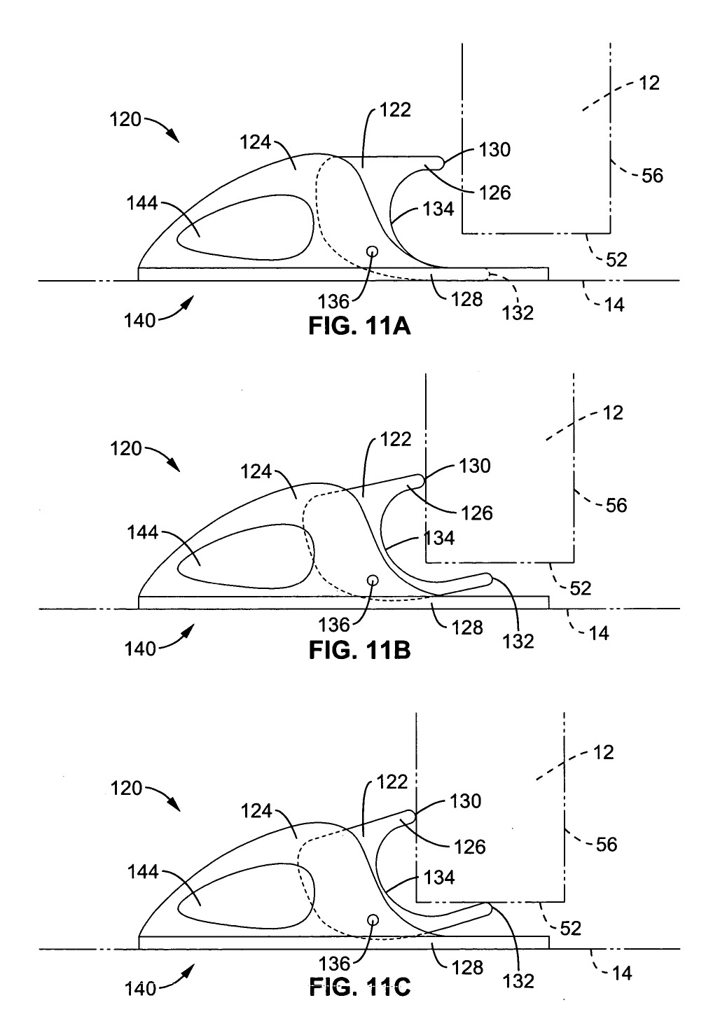

FIGS. 10A-11C illustrate an alternative doorstop 120 incorporating a pivoting contact element 122 and stationary base 124. Contact element 122 is a crescent-shaped pivotable member having an upper arm 126 and lower arm 128 defining opposite ends of curvilinear cutout 134. Contact element 122 is pivotably connected to the stationary base 124 via a pivot pin 136. Contact element 122 has an upper contact point 130 located on the foremost tip of upper arm 126, and a lower contact point 132 located on the foremost tip of lower arm 128. The stationary base 124 has a lower surface 140 configured to interface with the ground or floor at a preferably high coefficient of friction. To increase friction, protrusions 142 may be positioned on the bottom surface 140 to catch the mating surface of the floor. The protrusions 142 may also be comprised of a high grip rubber, plastic or similar material to increase frictional resistance.

FIGS. 11A-11C illustrate the mechanics of doorstop 120 in accordance with the present invention. As illustrated in FIG. 11A, the loading force L imposed on the door 12 advanced the door 12 past the bottom arm 128 and lower portion of the base 124. The door 12 then impacts the upper arm 126 at upper contact point 130, causing the contact element 122 to pivot about pivot pin 136, as shown in FIG. 11B. The lower arm 128 rotates upward as a result of this loading, until the lower contact point locks onto the bottom surface 52 of door 12. The motion of the door is then restrained as a result of the downward loading force F_{d}, which is similar to the diagram of FIG. 3C. To release the door, pressure is applied in the opposite direction of loading force F_{d}, causing the contact element to pivot forward. The doorstop 120 may then be removed from the location to allow the door to move through its normal range of motion. A torsion spring (or other spring) may be couple the contact element with the pivot pint 136 such that the contact element 122 returns to its initial placement as shown in FIG. 11A.

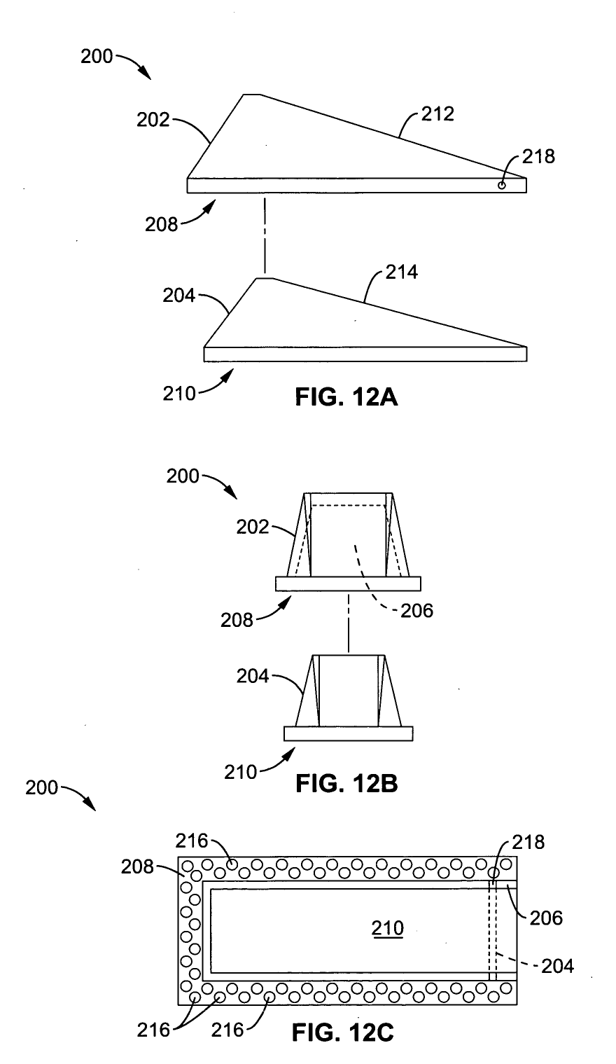

FIGS. 12A-12C illustrate an alternative 2-piece wedge-shaped doorstop 200 in accordance with the present invention. The doorstop 200 comprises an outer wedge member 202 that has a cavity 206 at lower surface 208 such that an inner wedge member 204 may be stored during use. As shown in side view 12A and rear view 12B, the inner wedge member 204 is smaller to fit in the cavity 206 of outer wedge member 202, as shown in the bottom view of FIG. 12C. The perimeter of bottom surface 208 may have buttons 216 to increase surface friction.

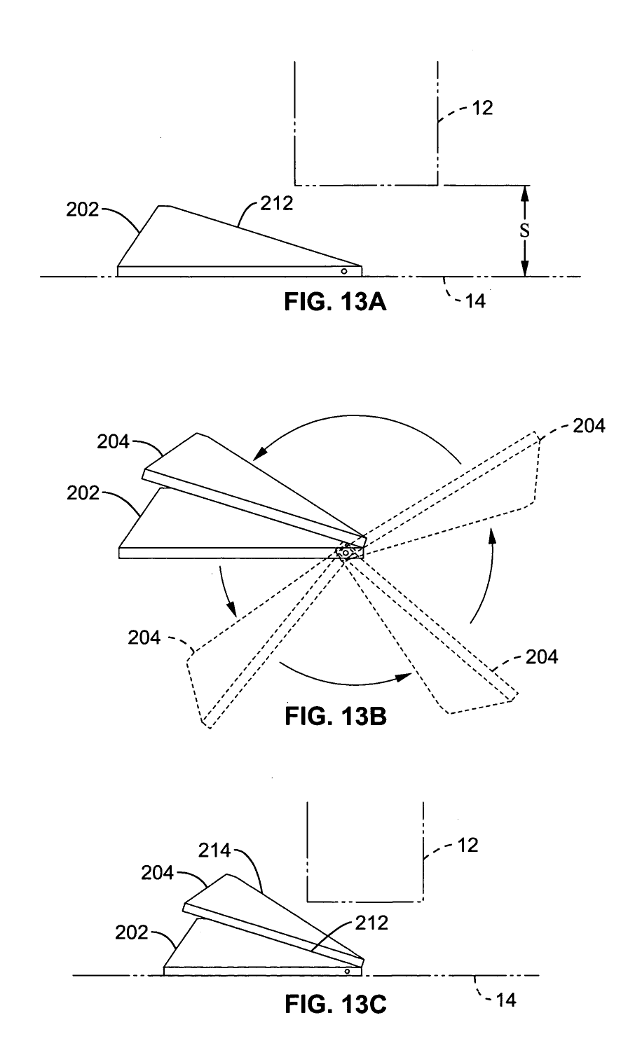

Referring to FIGS. 13A-13C, the inner wedge 204 may be removed from the cavity 206 of outer wedge 202 and rotated to securely rest on the top slope 212 of outer wedge 202. The additional top slope 214 of inner wedge 204 creates a larger profile to accommodate a large gap S that would normally have allowed the door 12 to move past the doorstop but for the increase height.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. A doorstop, comprising:
a base portion having a lower surface for placement on a surface in proximity to a door;
a first arm coupled to the base portion;
the first arm configured to engage the door as a result of motion of the door in a first direction; and
a second arm coupled to the base portion;
the second arm configured to engage the door as a result of engagement of the first arm with the door;
wherein engagement between the first and second arms and the door retains motion of the door in the first direction.

2. A doorstop as recited in claim 1:
wherein the first arm is configured to engage a first surface of a door as a result of motion of the door in the first direction; and
wherein engagement of the first arm with the first surface of the door causes at least a portion of the doorstop to pivot to engage the second arm with the second surface of the door.

3. A doorstop as recited in claim 2, wherein the second surface is substantially perpendicular to the first surface.

4. A doorstop as recited in claim 2:
wherein the base portion has a lower surface for placement on a surface in proximity to the door;
wherein a portion of the lower surface comprises a curvilinear surface; and
wherein the first arm is configured such that engagement of the first arm with the first surface of the door causes the doorstop to rock backward on said curvilinear surface to engage the second arm with the second surface.

5. A doorstop as recited in claim 4, wherein the surface in proximity to the door comprises a floor surface below said door.

6. A doorstop as recited in claim 5:
wherein the first surface comprises a front panel of the door; and
wherein the second surface comprises a bottom panel of the door.

7. A doorstop as recited in claim 6:
wherein the second arm is configured to fit under a gap between the floor surface and the bottom panel of the door; and
wherein the second arm allows motion of the door over the second arm prior to contacting the first arm.

8. A doorstep as recited in claim 7, wherein the second arm rotates upward to engage the bottom panel of the door as the doorstop rocks on said curvilinear surface.

9. A doorstop as recited in claim 5:
wherein the door is balanced between the first arm and the second arm to generate a vertical force between the floor and the lower surface of the doorstop; and
wherein the vertical force restraining motion of the door in the first direction.

10. A doorstop as recited in claim 4:
wherein the surface in proximity to the door comprises a door jam surface; and
wherein the first surface is a hinge panel of the door, and the second surface is a rear panel of the door.

11. A doorstop as recited in claim 2:
wherein the first arm and the second arm define a pivoting member pivotably connected to the base portion; and
wherein engagement of the first arm with the first surface causes the pivoting member to pivot such that the second arm moves toward the second surface to engage the second surface.

12. A method of restraining motion of a door in a first direction, comprising:
placing a doorstop on a surface in proximity of the door;
said doorstop having a first contact point and a second contact point;
engaging the first contact point of the doorstop as a result of motion of the door in the first direction;
engaging the second contact point of the doorstop as a result of motion of the first contact point in the first direction; and
balancing the door between the first contact point, second contact point, and proximate surface to restrain the door from moving in the first direction.

13. A method as recited in claim 12, wherein:
engaging the first contact point comprises engaging a first surface of the door as a result of motion of the door in the first direction; and
engaging the first contact point comprises engaging a second surface of the door as a result of motion of the first contact point in the first direction.

14. A method as recited in claim 12, further comprising:
rocking at least a portion of the doorstop as a result of motion of the first contact point in the first direction.

15. A method as recited in claim 14:
wherein the doorstop comprises a lower surface;
wherein a portion of the lower surface comprising a curvilinear surface; and
wherein rocking at least a portion of the doorstop comprises engaging the first contact point with the first surface of the door such that the doorstop rocks backward on said curvilinear surface to engage the second contact point with the second surface.

16. A method as recited in claim 14:
wherein the first contact point and second contact point are located on a pivoting member pivotably connected to a base member of the doorstop; and
wherein rocking at least a portion of the doorstop comprises engaging the first contact point with the first surface of the door such that the pivoting member pivots backward on said curvilinear surface to engage the second contact point with the second surface.

17. A method as recited in claim 14:
wherein placing a doorstop on a surface comprises placing the doorstop on a floor surface in front of the door;
wherein a front surface of the door engages the first contact point as a result of motion of the door in the first direction; and
wherein the second contact point engages a bottom surface of the door as a result of motion of the first contact point in the first direction.

18. A method as recited in claim 17:
wherein the door advances over the second contact point prior to engaging the first contact point; and
wherein the second contact point rotates upward to engage the bottom surface of the door.

19. A method as recited in claim 17:
wherein the door is balanced between the first contact point and the second contact point to generate a vertical force between the floor and doorstop; and
wherein the vertical force restrains motion of the door in the first direction.

20. A method as recited in claim 17, further comprising:
applying pressure to the door in a second direction to disengage the doorstop from the door;
the second direction being substantially opposite to said first direction.

21. A doorstop for retaining a door, the door moving in a first direction under a force directed substantially in the first direction, comprising:
a base member comprising a first contact point and a second contact point; and
means for balancing the door between the first contact point and the second contact point to retain the door from motion in the first direction.

22. A doorstop as recited in claim 21:
wherein the base member further comprises a lower surface configured to engage a floor surface in proximity to the door;
wherein the first direction is substantially parallel to the floor surface; and
wherein the first contact point and the second contact point are configured to transfer at least a portion of the force to a second direction; and
wherein the second direction has a vertical component.

23. A doorstop as recited in claim 22, wherein said vertical component contributes to a static friction force opposing the door in the first direction.

24. A doorstop as recited in claim 21, further comprising an anti-sliding means coupled to the base member.

25. A doorstop as recited in claim 24, wherein the anti-sliding means is integral with base member.

26. A doorstop as recited in claim 24, wherein the anti-sliding means comprises a separate layer attached to the base member.

27. A doorstop as recited in claim 21, wherein the first contact point and the second contact point are configured to interface with a first door surface and a second door surface respectively.

28. A doorstop as recited in claim 27, wherein the first door surface is substantially perpendicular to the second door surface.

29. A doorstop as recited in claim 22:
wherein the balancing means comprises a curvilinear surface on the lower surface of the body member; and
wherein said curvilinear surface is configured to allow the doorstop to rock backward to contact the door with the second contact point after engagement with the door and the first contact point.

30. A doorstop as recited in claim 22:
wherein said balancing means comprises a pivoting member housing the first contact point and the second contact point; and
wherein said pivoting member is configured to pivot about a point on the base member upon engagement of the first contact point and the door.

31-39. (canceled)
